(19) United States
(12) Patent Application Publication
(10) Pub. No.: US 2025/0253459 A1
(43) Pub. Date: Aug. 7, 2025

(54) BATTERY PACK

(71) Applicant: TOYOTA JIDOSHA KABUSHIKI KAISHA, Toyota-shi Aichi-ken (JP)

(72) Inventor: Masataka SATOH, Sunto-gun Shizuoka-ken (JP)

(73) Assignee: TOYOTA JIDOSHA KABUSHIKI KAISHA, Toyota-shi Aichi-ken (JP)

(21) Appl. No.: 19/010,758

(22) Filed: Jan. 6, 2025

(30) Foreign Application Priority Data
Feb. 1, 2024 (JP) 2024-014223

(51) Int. Cl. H01M 50/204; H01M 50/24; H01M 50/503; H01M 50/505

(52) U.S. Cl. CPC H01M 50/204; H01M 50/24; H01M 50/503; H01M 50/505

(57) ABSTRACT

A battery pack includes: a case; a current collector plate; and a plurality of battery modules stacked along a stacking direction and fixed to the case via the current collector plate. An area of the current collector plate in a lateral direction perpendicular to the stacking direction is smaller than an area of each of the battery modules in the lateral direction.

### BACKGROUND

The present application claims priority to and incorporates by reference the entire contents of Japanese Patent Application No. 2024-014223 filed in Japan on Feb. 1, 2024.

The present disclosure relates to a battery pack.

JP 2018-28977 discloses a bipolar battery in which a plurality of unit cells are stacked in the stacking direction. In this technique, a current collector plate is arranged on the upper surface and the lower surface in the stacking direction in each of a plurality of unit cells.

### SUMMARY

Incidentally, in the case of arranging the current collector plate inside the battery pack case upper surface and lower surface, respectively, which houses a battery module composed of a plurality of unit cells, when the outside air is in a low temperature environment, the cold air from the outside air will be transferred heat to the battery module through the current collector plate, the performance of the battery module will be lowered, there is room for improvement.

There is a need for a battery pack capable of preventing the performance of the battery module from being deteriorated even when the outside air is in a low-temperature environment.

According to one aspect of the present disclosure, there is provided a battery pack including: a case; a current collector plate; and a plurality of battery modules stacked along a stacking direction and fixed to the case via the current collector plate, wherein an area of the current collector plate in a lateral direction perpendicular to the stacking direction is smaller than an area of each of the battery modules in the lateral direction.

### BRIEF DESCRIPTION OF THE DRAWINGS

FIG. 1 is a cross-sectional view showing a schematic configuration of a battery pack according to an embodiment;

FIG. 2 is a plan view showing the relationship between the lower current collector plate and the battery module provided in the battery pack according to the embodiment;

FIG. 3 is a diagram showing a relationship between temperature and time in the temperature distribution between the battery modules in the battery pack according to the embodiment;

FIG. 4A is a diagram showing before improvement of the temperature distribution in the battery module at a specified time of the battery pack according to the embodiment;

FIG. 4B is a diagram showing after improvement of the temperature distribution in the battery module at a specified time of the battery pack according to the embodiment;

FIG. 5 is a cross-sectional view showing a schematic configuration of a battery pack according to a modification of the embodiment; and

FIG. 6 is a plan view showing the relationship between the lower current collector plate and the battery module 5 provided in the battery pack according to a modification of the embodiment.

### DETAILED DESCRIPTION

Hereinafter, a battery pack according to an embodiment of the present disclosure will be described with reference to the drawings. Note that the components in the following embodiments include those which can be substituted and easily by those skilled in the art, or those which are substantially the same. Further, the drawings referred to in the following description are only schematically showing the shape, size, and positional relationship to the extent that the contents of the present disclosure can be understood. In other words, the present disclosure is not limited only to the shape, size, and positional relationship exemplified in each of the figures.

### Configuration of Electric Pack

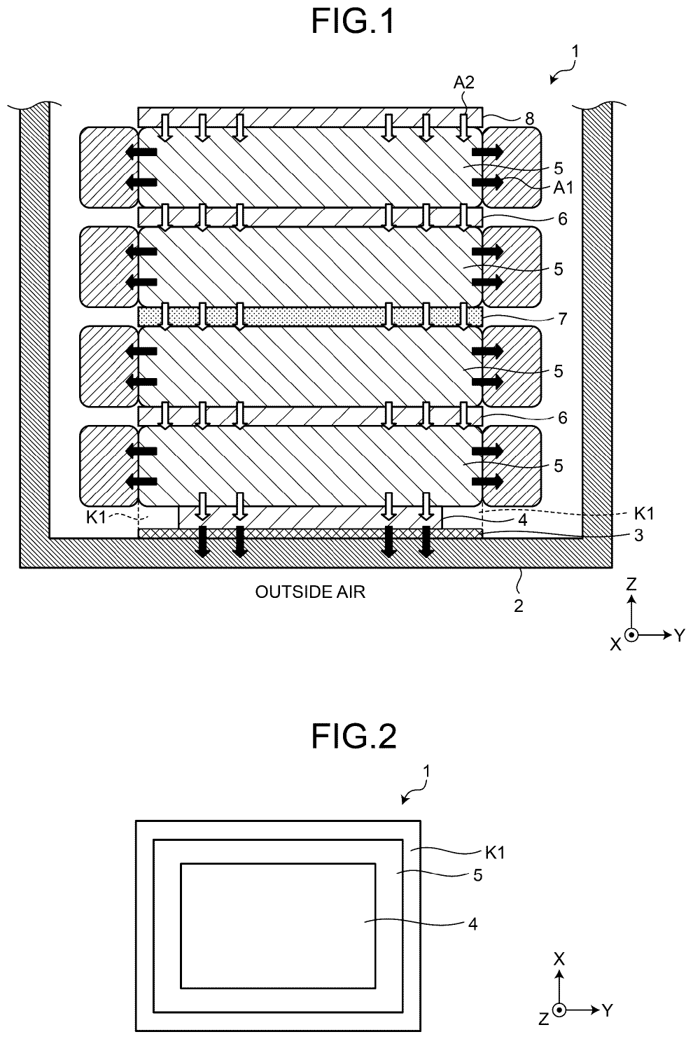

FIG. 1 is a cross-sectional view showing a schematic configuration of a battery pack according to the embodiment. A battery pack 1 illustrated in FIG. 1 is configured to include a nickel-metal hydride battery of bipolar type, it is mounted on a vehicle or the like.

The battery pack 1 includes: a case 2; a current collector plate 4 provided on the bottom surface of the case 2 through the insulating member 3 (hereinafter, simply referred to as “lower current collector plate 4”); and a plurality of battery modules 5 stacked along the stacking direction (Z direction) and fixed to the case 2 through the lower current collector plate 4. In addition, the battery pack 1 includes, between adjacent battery modules 5, a cooling device 6 in which a refrigerant for cooling the battery modules 5 flows through the inside, a current-carrying plate 7 that electrically connects the adjacent battery modules 5 to each other, and a top current collector plate 8. In FIG. 1, an example in which four battery modules 5 are stacked will be described, without being limited thereto, the number of battery modules 5 can be changed as appropriate.

The battery pack 1 configured in this way is laminated with the lower surface current collector plate 4, the plurality of battery modules 5, the cooler 6, the current conducting plate 7, and the upper surface current collector plate 8 electrically connected to each other so as to be able to conduct current and heat, as illustrated by the white arrow A2. Furthermore, the battery pack 1, the lower surface current collector plate 4 is a solid heat conduction with the outside air contact components such as the case 2 through the insulating member 3, and also serves as a current supply path and a heat radiation path of the battery module 5. Furthermore, as illustrated in the black-painted arrow A1, a plurality of battery modules 5 are formed partially laminated so as not to touch. In FIG. 1, the black-painted arrow A1 represents the heat transfer direction of the heat transfer, white arrow A2 indicates the conduction direction of the conduction direction and the heat transfer of the current.

Here, it will be described in detail lower current collector plate 4. FIG. 2 is a plan view showing the relationship between the lower current collector plate 4 and the battery module 5. As illustrated in FIGS. 1 and 2, the lower surface current collector plate 4, the area of the horizontal plane in the lateral direction (X direction and Y direction) perpendicular to the stacking direction (Z direction) in which the battery module 5 is stacked, in the lateral direction (X direction and Y direction) in the battery module 5 smaller than the area of the horizontal plane.

Specifically, as illustrated in FIG. 2, the lower surface current collector plate 4 is formed to be smaller so as to be positioned only inside the battery module 5 in the lateral direction perpendicular to the stacking direction (Z direction) in which the battery module 5 is stacked. Further, the lower surface current collector plate 4, if the heat insulation requirements are high, the electrical resistance is made of a high material, for example, aluminum or stainless steel or the like. Incidentally, the lower surface current collector plate 4, when the heat insulation requirement is low, the electrical resistance is low material, may be formed using, for example, copper or the like.

Furthermore, the lower surface current collector plate 4, with respect to the stacking direction, has a predetermined thickness for increasing the heat insulating effect from the outside air of the case 2. The predetermined thickness, the thickness of the space K1 between the insulating member 3 and the lower surface of the battery module 5 (height), the thickness of the air is not operated as a fluid, i.e., not heat transfer.

According to the battery pack 1 configured in this way, since the area of the horizontal surface in the lateral direction in the lower surface current collector plate 4 is smaller than the area of the horizontal surface in the lateral direction of the battery module 5, the calorific value of the battery module 5 is increased. Furthermore, since the area of the horizontal surface in the lateral direction in the lower surface current collecting plate 4 close to the outside air is small, the battery pack 1, with respect to the battery module 5, by creating a portion that does not contact the case 2 (spatial K1), the heat transfer from the outside air through the case 2 can be suppressed, it is possible to keep the battery module 5 warm.

### Temperature Distribution Between Battery Modules

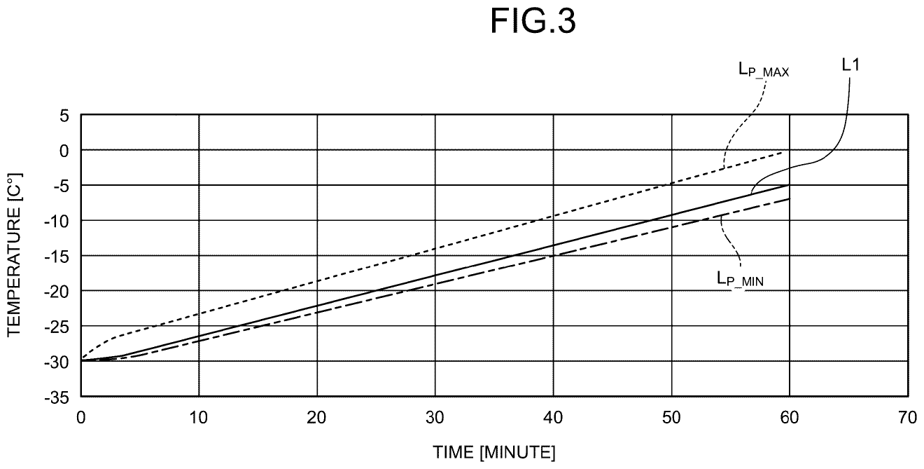

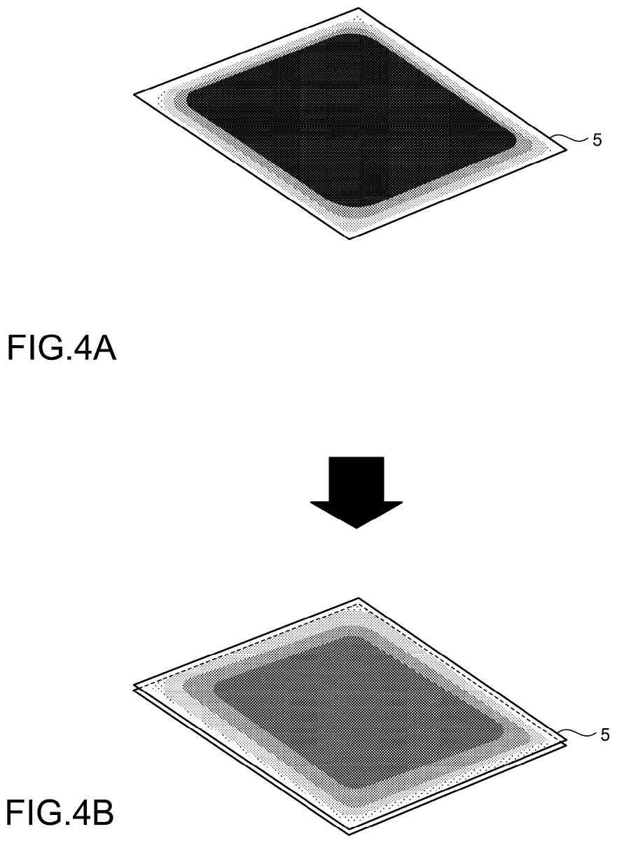

Next, the temperature distribution between the battery modules 5 in the battery pack 1 will be described. FIG. 3 is a diagram showing a relationship between temperature and time in the temperature distribution between the battery modules 5 in the battery pack 1. FIG. 4A is a diagram showing before and FIG. 4B is a diagram showing after improvement of the temperature distribution in the battery module 5 at a specified time of the battery pack 1. In FIG. 3, the horizontal axis represents time [minute], the vertical axis represents the temperature [C°]. Furthermore, in FIG. 3, the linear L1 indicates the time variation of the temperature distribution between the battery modules 5 in the battery pack 1 using the lower surface current collecting plate 4, the linear L_{P_MAX} indicates the time variation of the temperature distribution maximum value between the battery modules 5 in the conventional battery pack 1, and the linear L_{P_MIN} indicates the time variation of the temperature distribution minimum value between the battery modules 5 in the conventional battery pack 1. In FIG. 4A, the higher the temperature of the battery module 5 is expressed as black.

Linear L1 of FIG. 3, as illustrated in the linear L_{P_MAX} and linear L_{P_MIN}, the battery module 5, since the temperature distribution is relaxed (FIG. 4(A) to FIG. 4(B)), it is possible to suppress the heat generation of the battery module 5, it is possible to keep the battery module 5 warm.

According to the embodiment described above, since the area of the horizontal surface in the lateral direction of the lower surface current collecting plate 4 is smaller than the area of the horizontal surface in the lateral direction of the battery module 5, even when the outside air is in a low temperature environment, it is possible to prevent the performance of the battery module 5 from being deteriorated.

Further, according to the embodiment, since the lower surface current collector plate 4 is positioned only inside the battery module 5 in the lateral direction perpendicular to the stacking direction, by insulating the outer peripheral portion of the battery module 5, the temperature of the battery module 5 it is possible to suppress a decrease in.

Further, according to the embodiment, since the lower surface current collecting plate 4 is formed using aluminum or stainless steel or the like of a material having a high electrical resistance, raising the electrical resistance, by increasing the calorific value at the time of energization, the battery pack 1 it is possible to raise the temperature.

### Modified Example

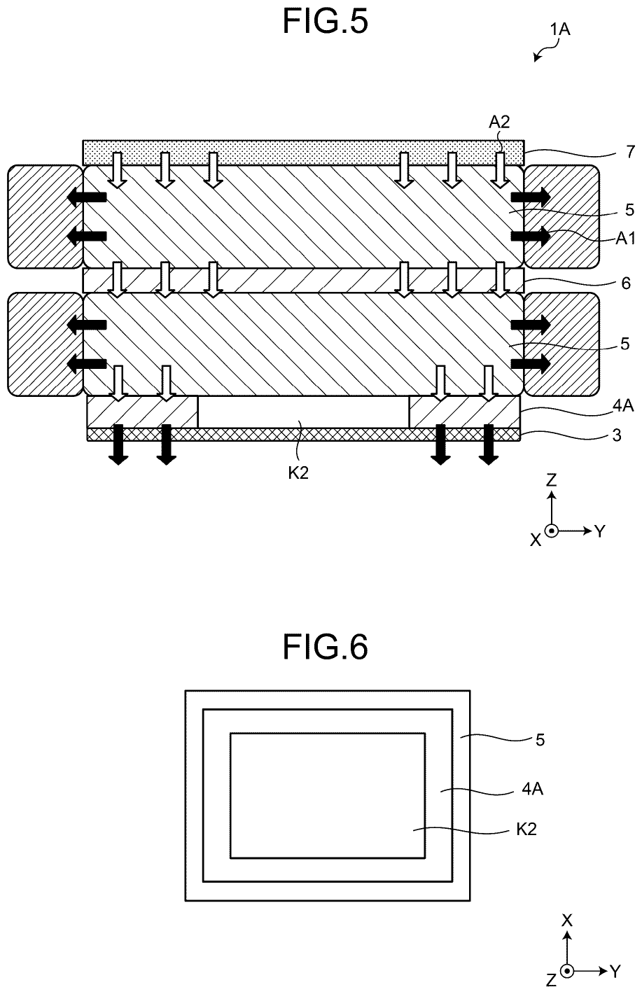

FIG. 5 is a sectional view showing a schematic configuration of a battery pack according to a modification of the embodiment. FIG. 6 is a plan view showing the relationship between the lower current collector plate and the battery module 5 provided in the battery pack according to the modification of the embodiment. A battery pack 1A illustrated in FIGS. 5 and 6 includes a lower current collector plate 4A instead of the lower current collector plate 4 described above. The lower current collector plate 4A has a square tube shape. Thus, between the lower current collector plate 4A and the battery module 5, a space K2 is formed therein. The lower current collector plate 4A is made of a material having a high-electrical-resistance, for example, aluminum or stainless-steel.

Furthermore, the lower surface current collector plate 4A, with respect to the stacking direction of the battery module 5, has a predetermined thickness for increasing the thermal insulation effectiveness from the outside air of the case 2. The predetermined thickness, the thickness of the space K2 between the insulating member 3 and the lower surface of the battery module 5 (height), the thickness of the air is not operated as a fluid, i.e., not heat transfer.

According to the modified example of the embodiment described above, since the battery pack 1A can increase the heat generating amount of the periphery of the battery module 5, warming the periphery of the battery module 5 in which the temperature is likely to decrease, it is possible to suppress the temperature decrease in the vicinity of the periphery of the battery module 5.

In the modified example of the embodiment, the lower current collector plate 4A has made a square tube shape, without being limited thereto, for example, a tubular or honeycomb structure it may be, may be any shape as long as it is possible to form a space therein.

According to the present disclosure, even when the outside air is in a low-temperature environment, an effect that it is possible to prevent the performance of the battery module from being deteriorated.

Further effects and variations can be readily derived by one of ordinary skill in the art. The broader aspects of the disclosure are not limited to the specific details and representative embodiments expressed and described above.

Accordingly, various changes may be made without departing from the spirit or scope of the overall inventive concept defined by the appended claims and their equivalents.

While the embodiment of the present application has been described in detail based on the drawings, it is illustrative, and it is possible to implement the present disclosure in other forms which are variously modified and improved based on the knowledge of those skilled in the art, starting from the aspects described in the column of the disclosure.

What is claimed is:

1. A battery pack comprising:
a case;
a current collector plate; and
a plurality of battery modules stacked along a stacking direction and fixed to the case via the current collector plate,
wherein an area of the current collector plate in a lateral direction perpendicular to the stacking direction is smaller than an area of each of the battery modules in the lateral direction.

2. The battery pack according to claim 1, wherein the current collector plate is positioned only inside the battery module in the lateral direction.

3. The battery pack according to claim 1, wherein the current collector plate has a square tube shape.

4. The battery pack according to claim 1, wherein the current collector plate is formed of aluminum or stainless steel.
